(19) United States
(12) Patent Application Publication
(10) Pub. No.: US 2012/0316830 A1
(43) Pub. Date: Dec. 13, 2012

(54) COUPLED MULTI-WAVELENGTH CONFOCAL SYSTEMS FOR DISTANCE MEASUREMENTS

(76) Inventor: Ophir Eyal, Ramat Hasharon (IL)

(21) Appl. No.: 13/156,572

(22) Filed: Jun. 9, 2011

(51) Int. Cl. G01B 11/14

(52) U.S. Cl. 702/159

(57) ABSTRACT

A system for measuring a distance to a substrate includes a first light source, emitting a first wavelength on a region of the substrate though a lens. A second light source emits a second wavelength region of the substrate through the lens. A first and second detector are configured to detect the first and second wavelength light reflected from the substrate. A processor is configured to compute a first response function wherein the first response function represents reflected light intensity emitted from the first light source as a function of the distance between the imaging device and substrate. A second response function represents reflected light intensity emitted from the second light source as a function of the distance between the imaging device and substrate. A ratio response function represents the ratio of the first and second response function as a function of distance between the imaging device and substrate.

### CROSS REFERENCE TO RELATED APPLICATIONS

Reference is made to commonly-assigned copending U.S. patent application Ser. No. ______ (Attorney Docket No. K000381US01/NAB)., filed herewith, entitled COUPLE MULTI-WAVELENGTH CONFOCAL SYSTEMS FOR DISTANCE MEASUREMENTS, by Eyal; the disclosure of which is incorporated herein.

### FIELD OF THE INVENTION

The present invention relates to an apparatus for measuring distance between media and an imaging head for a computer-to-plate (CTP) imaging device.

### BACKGROUND OF THE INVENTION

The basic confocal technique was invented by Marvin Minsky and is since well known in the literature in different forms. The fundamental principles and advantages of confocal microscopy are described in U.S. Pat. No. 3,013,467 (Minsky et al.).

Shafir et al. in the article, “Expanding the realm of fiber optic confocal sensing for probing position, displacement, and velocity,” Applied Optics Vol. 45, No. 30, 20 Oct. 2006, uses different wavelengths and adjusts the fiber tips at different focal planes of the imaging lens. Shafir et al., however, does not use the ratio of signal for distance measurements.

U.S. Pat. No. 6,353,216 (Oren et al.) also uses a confocal system and different wavelengths. The different signals in this patent are used in order to determine the direction of the movement. The idea of using the ratio of two signals for distance measurements is not mentioned.

The confocal signal obtained in the referenced prior art is dependent on the reflectivity of the sample. Furthermore the confocal signal is also dependent on the optical transmittance of the medium in front of the sample. There is, therefore, a need for a confocal signal that will be immune or at least less dependent on the reflectivity and optical transmittance of the medium.

### SUMMARY OF THE INVENTION

Briefly, according to one aspect of the present invention a system for measuring a distance to a substrate includes a first light source, emitting a first wavelength on a region of the substrate though a lens. A second light source emits a second wavelength region of the substrate through the lens. A first and second detector are configured to detect the first and second wavelength light reflected from the substrate. A processor is configured to compute a first response function wherein the first response function represents reflected light intensity emitted from the first light source as a function of the distance between the imaging device and substrate. A second response function represents reflected light intensity emitted from the second light source as a function of the distance between the imaging device and substrate. A ratio response function represents the ratio of the first and second response function as a function of distance between the imaging device and substrate.

The present invention suggests a confocal system in which the sample is illuminated simultaneously by two different wavelengths. The ratio of the back reflected signals from the sample is immune or less sensitive to parameters such as the reflectivity and the optical transmittance of the medium in front of the sample.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 a prior art illustration of confocal sensor used to measure the reflection from an imaged substrate;

FIG. 2 a prior art schematic showing a response function of reflected light intensity from an imaged substrate—maximal value represents focus;

FIG. 3 an illustration of a confocal system using two light sources with different wavelength each;

FIG. 4A illustrates the shift between two response functions; and

FIG. 4B illustrates the ratio of two response functions.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

While the present invention is described in connection with one of the embodiments, it will be understood that it is not intended to limit the invention to this embodiment. On the contrary, it is intended to cover alternatives, modifications, and equivalents as covered by the appended claims.

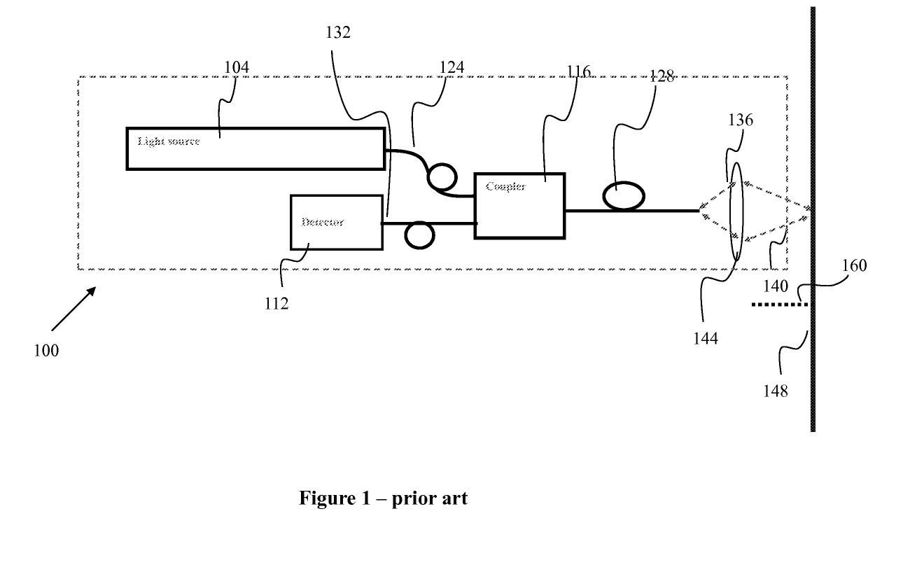

FIG. 1 illustrates a common and well known structure of fiber optic confocal sensor 100. The confocal sensor 100 is comprised of a light source 104 coupled to optical fiber 124 and to fiber optic coupler 116. Rays 136 emitted from optical fiber 128 via imaging lens 144 are imaged on the surface of substrate 148. The back reflected light 140 is coupled to the emitting optical fiber 128 and reaches light detector 112 via coupler 116 and optical fiber 132. The intensity measured by light detector 112 is a function of the distance, z, 160 to substrate 148.

The principle of this disclosure is described herein. The signal measured by the detector, Vd, is proportional and is a function of few parameters:
Vd(λ,z) α Io×G(λ,z)×ρ(λ)×T(λ,z). Where, α represents a proportional sign.
Io is the intensity of the light that impinges on the sample.
ρ(λ) is the reflectivity of the sample.
T(λ,z) is the optical transmittance of the medium between the sample and the imaging lens.
Z is the distance to the sample.
G(λ,z) is a function describing the overall optical response of the confocal system. It is a function of the distance, z, and of the wavelength λ, and defined also by optical parameters of the confocal system such as the numerical aperture of the lens and of the diameter of the fiber's core.

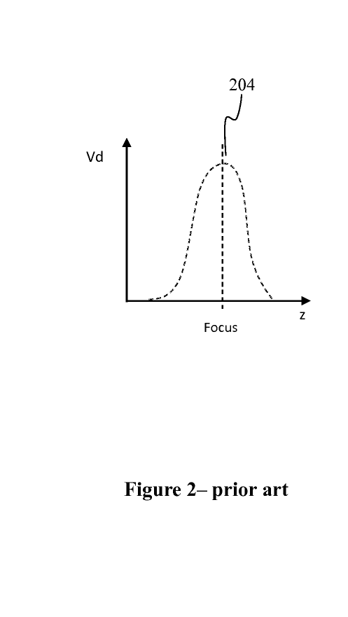

FIG. 2 is graph describing typical and well known confocal signal where a symmetrical curve describes Vd(λ,z) as a function of the distance Z. Such a curve is measured by simultaneously reading Vd(λ,z) and while scanning with the confocal system along the z axis and at known positions. The best focus is defined at the maximum 204 of the symmetrical function. The graph describes the ambiguity of a typical confocal system. A single value of Vd(λ,z) corresponds to two different values of the position z.

The scan along the z axis can be done in several techniques, for example by using an autofocus system embedded within a compound lens 336, constructed from several optical elements, where some of them can be moved and controlled in order to change and adjust the lens focal distance.

The signal, Vd(z), as can be seen from the equation, is dependent also on the reflectivity, ρ(λ), of the sample and the optical transmittance, T(λ,z), of the medium. This means that at best focus, different intensities will be measured for samples having different reflectivity.

Furthermore, for a specific sample and although positioned at best focus, the intensity measured by the detector, will change if the sample reflectivity or the optical transmittance of the medium change during the measurement procedure. In such cases, therefore, one has to repeatedly scan the peak in order verify the position of the best focus.

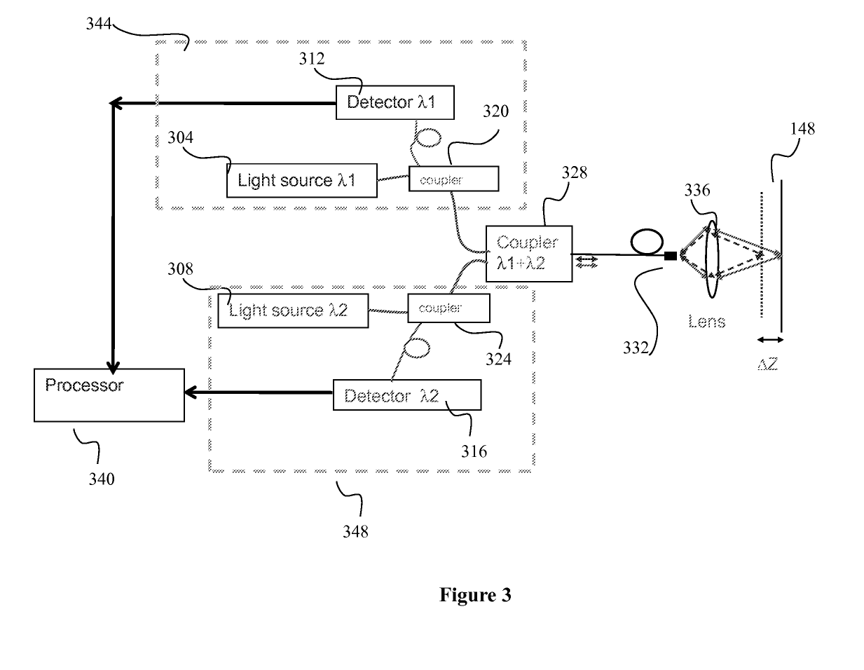

FIG. 3 describes the basic principle of the present invention using a fiber optic confocal system where at least two coupled light source and detector units 344 and 348 are used. Light sources 304 (from unit 344) and 308 (from unit 348) each emitting different wavelengths. Light source 304 is coupled via fiber optic coupler 320 to detector 312. First detector 312 is constructed to be sensitive just to wavelength λ1, emitted by first light source 304. Second light source 308 is coupled via fiber optic coupler 324 to second detector 316. Second detector 316 is constructed to be sensitive just to wavelength λ2, emitted by second light source 308. Units 344 and 348 are further coupled by fiber optic coupler 328 to emit combined light via a single output port 332. Output optical port 332 is imaged via a dispersive optical element 336 on substrate 148. Due to the dispersion of 336 the wavelengths are focused on two different planes, shifted relative to each other by Δz.

Processor 340 forms a response function Vd(λ1,z), which is a function of the applied wavelength λ1 and the distance z between the lens 336 and substrate 148. Similarly, processor 340 forms a response function Vd(λ2,z), using a different wavelength λ2. Processor 340 computes along a defined range, a ratio response function which is a division of function Vd(λ1,z) and function Vd(λ2,z).

The computed ratio response function is an absolute and monotonic function of the distance z. Hence the ambiguity (related to common confocal systems) of the function Vd((λ, z) where one value fits two different z positions is omitted.

Furthermore, consider the case where the reflectivity; ρλ1 ρλ2, and the and optical transmittance; T(λ1,z) T(λ,z), are identical or change in the same way. In such a case the ratio signal, Vd(λ1,z)/Vd(λ2,z), will be independent or less sensitive to the reflectivity, ρ, and to the transmittance T. G(λ,z), describing the optical response of the confocal system is a function of optical parameters such as the numerical aperture of the lens and of the diameter of the fiber's core. By adjusting these optical parameters, the ratio Vd(λ1,z)/Vd(λ2,z) may be controlled, achieving for example the right dynamic range and accuracy.

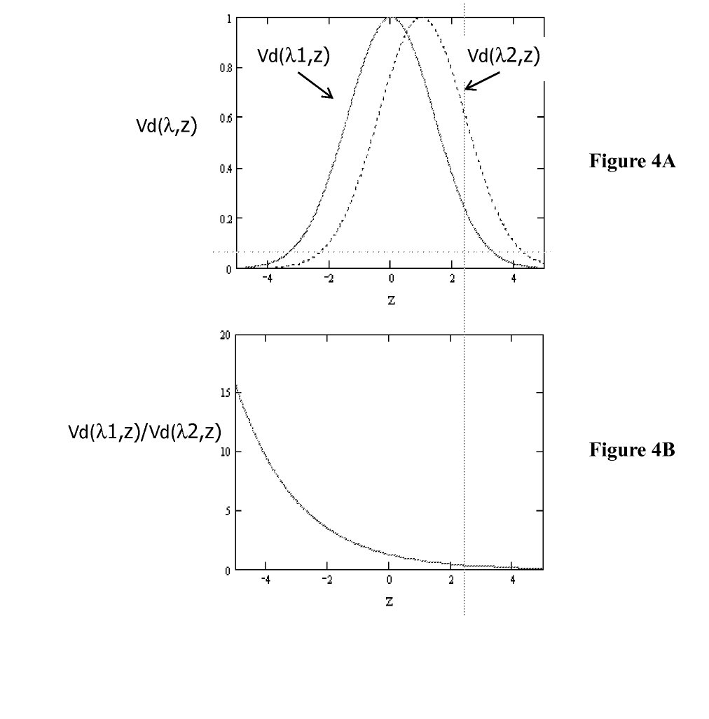

Assuming for simplicity the case where the optical response of the confocal system is the same, both for λ1 and λ2, and described by a Gussian function G(λ,z). FIG. 4A describes a lateral shift along the z axis between normalized function G(λ1,z) and normalized function G(λ2,z). This lateral shift is due to the dispersion of the imaging lens. FIG. 4B describes the ratio between G(λ1,z) and G(λ2,z).

Practically, optical detectors such as 312 and 316 can be made to be sensitive just to a single wavelength by using different types of detectors. One can also use identical detectors where adequate band pass filters are inserted in front of the detectors. Different bandpass filters can be used, for example, filters based on thin film technology or filters made from fiber Bragg gratings.

Different optical fibers and fiber optic couplers can be used in order to implement the invention. For example, multi and single mode optical fibers and couplers, wavelength and polarization dependent fiber optic couplers and fiber optic elements can be used.

Measurement can be done simultaneously by activating the light sources and measuring detected signals at the same time. Measurements can also be done by sequentially activating the different light sources and performing measurement with their related detectors. When operating in simultaneously sequential mode, there is no need to spectrally isolate the light detectors, since measurements are done at different times.

The basic principle of the invention was described via a fiber optic confocal system, described by FIG. 3. However, the principle can be implemented by using free space optics or by using a hybrid system where both fiber optic elements and free space optics are used. In the case of free space optics the output port 332 maybe for example a pin hole aperture.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

### PARTS LIST

100 confocal sensor
104 light source
112 light detector
116 fiber optic coupler
124 optical fiber connecting light source to coupler
128 optical fiber emitting light on substrate
132 optical fiber connecting coupler to detector
136 emitted rays to substrate
140 back reflected rays from substrate
144 imaging lens
148 substrate
160 distance, z, from lens to printing plate
204 maximal focus
304 first light source
308 second light source
312 first detector
316 second detector
320 coupler
324 coupler
328 coupler between first and second light sources
332 output optical port
336 dispersive lens
340 processor
344 coupled light source and detector unit
348 coupled light source and detector unit

1. A system for measuring a distance to a substrate comprising:
a first light source, emitting a first wavelength on a region of the substrate through a lens;
a second light source emitting a second wavelength on the region of the substrate through the lens;
wherein the lens is confocal and dispersive;
a first detector configured to detect first wavelength light reflected from the substrate;
a second detector configured to detect second wavelength light reflected from the substrate; and
a processor configured to compute:
a) a first response function wherein the first response function represents reflected light intensity emitted from the first light source as a function of the distance between the imaging device and substrate;
b) a second response function wherein the second response function represents reflected light intensity emitted from the second light source as a function of the distance between the imaging device and substrate; and
c) a ratio response function wherein the ratio response function represents the ratio of the first response function and the second response function as a function of distance between the imaging device and substrate.

2. The system in claim 1 wherein more than two light sources and detectors are used and wherein each of the light sources emits light of a different wavelength.

3. The system of claim 1 wherein the laser sources and the detectors are coupled by fiber optic couplers.

4. The system of claim 1 wherein the optical port is the distal tip of a fiber.

5. The system of claim 1 wherein the laser source and detectors are coupled utilizing mirrors, reflectors, optical fibers, and fiber optic elements.

6. The system of claim 1 wherein the optical port is a pin hole.

7. The system of claim 1 wherein the optical element is composed of mirrors and lenses.

8. The system of claim 1 wherein the optical element is a telemetric lens.

9. The system of claim 1 wherein the detector is a photonic or bolometric detector.
